(19) United States
(12) Patent Application Publication
(10) Pub. No.: US 2026/0016057 A1
(43) Pub. Date: Jan. 15, 2026

(54) Wheel Carrier And Brake Caliper Device And Wheel Carrier And Brake Caliper Module

(71) Applicant: Rheinmetall Invent GmbH, Neuss (DE)

(72) Inventors: Ralf Pasman, Cologne (DE); Carmelo Veneziano, Untereisesheim (DE); Steffen Ziegler, Schwaigern (DE); Ingo Roth, Pfedelbach (DE)

(21) Appl. No.: 18/993,039

(22) PCT Filed: Jul. 10, 2023
(86) PCT No.: PCT/EP2023/069036

§ 371 Date: Jan. 10, 2025

(30) Foreign Application Priority Data
Jul. 12, 2022 (DE) 10 2022 117 361.5

(51) Int. Cl. F16D 65/00; F16D 55/00; F16D 55/228; F16D 65/78; F16D 65/847

(52) U.S. Cl. CPC F16D 65/0062; F16D 55/228; F16D 65/847; F16D 2055/0012; F16D 2065/788

(57) ABSTRACT

A wheel carrier and brake caliper device for a vehicle including a wheel carrier, and a brake caliper. The wheel carrier and the brake caliper together form the wheel carrier and brake caliper device as an integral cast component. The wheel carrier and brake caliper device encloses a cavity through which cooling air can be passed for cooling the wheel carrier and brake caliper device. A wall of the wheel carrier and brake caliper device separates the cavity from a surroundings of the wheel carrier and includes an inner side facing the cavity and an outer side facing the surroundings. The wall inner side includes a greater surface roughness than the outer side.

### CROSS-REFERENCE TO RELATED APPLICATIONS

This application is filed pursuant to 35 U.S.C. § 371 claiming priority benefit to PCT/EP2023/069036 filed Jul. 10, 2023, which claims priority benefit to German Patent Application 102022117361.5 filed Jul. 12, 2022, the contents of both applications are incorporated by reference in the entirety for all purposes.

### TECHNICAL FIELD

The present invention relates to a wheel carrier and brake caliper device for a vehicle and to a wheel carrier and brake caliper module comprising such a wheel carrier and brake caliper device for a vehicle.

### BACKGROUND

A wheel suspension of a motor vehicle can comprise a wheel carrier and a brake caliper manufactured separately from the wheel carrier. The wheel carrier and the brake caliper are detachably connected to each other for mounting, for example with the help of screws. This design with two separate components in the form of the wheel carrier and the brake caliper results, for example, in design-related restrictions in rigidity, machining tolerances can accumulate, and the weight is high. External brake fluid lines are also required. The assembly of the wheel carrier and brake caliper requires a separate assembly step, whereby additional connecting components are required. This needs to be improved.

DE 603 04 537 T2 describes a wheel carrier and brake caliper arrangement comprising a wheel carrier and a brake caliper manufactured separately from the wheel carrier, which is bolted to the wheel carrier.

### SUMMARY

Against this background, one object of the present invention is to provide an improved wheel carrier and brake caliper device.

Accordingly, a wheel carrier and brake caliper device for a vehicle is proposed. The wheel carrier and brake caliper device comprises a wheel carrier and a brake caliper, wherein the wheel carrier and the brake caliper together form the wheel carrier and brake caliper device as an integral cast component, wherein the wheel carrier and brake caliper device encloses a cavity through which cooling air can be passed for cooling the wheel carrier and brake caliper device, wherein a wall of the wheel carrier and brake caliper device, which separates the cavity from a surroundings of the wheel carrier and brake caliper device, comprises an inner side facing the cavity and an outer side facing the surroundings, and wherein the inner side comprises a greater surface roughness than the outer side.

Due to the fact that the wheel carrier and the brake caliper are an integral cast component, there is no need to assemble the wheel carrier and the brake caliper. The cavity provided within the wheel carrier and brake caliper device advantageously enables cooling of the wheel carrier and brake caliper device, in particular the brake caliper. The cooling of the wheel carrier and brake caliper device can be optimized by the different surface roughnesses.

The wheel carrier and brake caliper device is preferably part of a chassis, in particular a wheel suspension, of the vehicle. Preferably, the vehicle comprises several wheel carrier and brake caliper devices. Each wheel of the vehicle can be assigned such a wheel carrier and brake caliper device. In the event that the vehicle comprises four wheels, it accordingly comprises four such wheel carrier and brake caliper devices.

The vehicle is a motor vehicle, in particular a passenger car. As previously mentioned, the vehicle comprises a plurality of wheels. For example, the vehicle may comprise four wheels. Of these, for example, two front wheels may be steered, and two rear wheels may be unsteered. Alternatively, all wheels can be steered. The wheel carrier and brake caliper device can be used for both a steered wheel and an unsteered wheel.

In particular, the wheel carrier is configured to rotatably support one of the wheels of the vehicle with the aid of a wheel bearing and a wheel hub. For this purpose, the wheel carrier comprises a basic section, which is preferably solid. A recess or breakthrough is provided on the basic section to accommodate the wheel bearing. The wheel bearing can be bolted or otherwise firmly connected to the wheel carrier.

The brake caliper is used to accommodate brake pistons and brake pads. Furthermore, a brake disc can be accommodated in the brake caliper, at least in sections. For this purpose, the brake caliper comprises a receiving section which holds the brake pistons, the brake pads and, at least in sections, the brake disc. The brake caliper can be part of a brake system of the vehicle.

In addition to the basic section, the wheel carrier preferably comprises a neck section and an arm section extending laterally out of the basic section. A first connection area for connecting a first or lower wishbone can be provided on the basic section. A second connection area can be provided on the arm section, which is used, for example, to connect a track rod to the wheel carrier and brake caliper device. The neck section can include a third connection area to which a second or upper wishbone can be attached.

The wheel carrier and brake caliper device is an integral component, in particular a one-piece material component. “Integral” or “one-piece” in this case means that the wheel carrier and brake caliper device is not composed of separate subcomponents, but that the wheel carrier and the brake caliper together form a common component, namely the wheel carrier and brake caliper device. In particular, this means that the wheel carrier and the brake caliper cannot be separated from each other in a non-destructive manner.

In the present case, “one-piece material” means that the wheel carrier and brake caliper device is made of the same material throughout. However, this does not exclude the possibility that the wheel carrier and brake caliper device may, for example, comprise insert components that are made of a different material. These insert components can, for example, be inserted into a mold for casting the wheel carrier and brake caliper device.

The fact that the wheel carrier and the brake caliper together form a one-piece or integral “cast component” means in particular that the wheel carrier and brake caliper device is manufactured using a casting process, such as a low-pressure casting process or a gravity casting process. In principle, however, any casting process can be used. Preferably, the wheel carrier and brake caliper device is made of an aluminum alloy. However, magnesium alloys or steel alloys can also be used.

The cavity is provided within the wheel carrier and brake caliper device. This means, in particular, that the wheel carrier and brake caliper device encloses the cavity or encloses it within itself. The cavity may be provided within the wheel carrier and/or within the brake caliper. This means that the cavity can be provided only within the wheel carrier, only within the brake caliper or both within the wheel carrier and within the brake caliper. Several cavities can be provided. In particular, this means that a separate cavity can be assigned to both the wheel carrier and the brake caliper.

In the present case, a “cavity” is to be understood as an area enclosed by the wheel carrier and brake caliper device, which is delimited from the surroundings of the wheel carrier and brake caliper device by means of a wall of the wheel carrier and brake caliper device, for example by means of the wall mentioned at the beginning. Accordingly, the cavity is surrounded by the wall, at least in sections. The wall encloses the cavity.

In contrast to this, a “bore” or a “breakthrough” is to be understood as an opening which, for example, breaks through a wall or the like with its entire cross-sectional area. In particular, this means that such a bore or breakthrough is not to be understood as a “cavity” as defined above. The cavity extends within the wheel carrier and brake caliper device from the preferably solid basic section into the neck section. The neck section comprises a smaller cross-sectional area compared to the basic section.

The wheel carrier and brake caliper device is assigned a coordinate system with an x-direction or length direction, a y-direction or height direction and a z-direction or depth direction. The directions are oriented perpendicular to each other. In particular, the cavity extends in the height direction of the wheel carrier and brake caliper device. The height direction is oriented from the first connection area or from the second connection area in the direction of the third connection area. The cavity preferably comprises its largest geometric extent along the height direction. This means that the geometric expansion of the cavity along the height direction is greater than along the length direction and the depth direction.

The different surface roughnesses can be produced by selecting a molding sand or molding salt with a specific particle size and/or particle geometry for a sand core or salt core that is used to form the cavity. For example, a center roughness value Ra of 15 μm is desired for the inner side. Accordingly, the outer side can comprise a center roughness value Ra of less than 15 μm.

The fact that the inner side is rougher than the outer side increases the heat transfer surface on the inner side. This improves heat dissipation from the wheel carrier and brake caliper device with the help of cooling air. The wall can be part of the wheel carrier, in particular the neck section. However, the wall can also be part of the brake caliper. In the present case, a “wall” means an area of the wheel carrier and brake caliper device that separates the respective cavity from the surroundings.

According to a further development, a wheel carrier and brake caliper device for a vehicle is proposed. The wheel carrier and brake caliper device comprises a wheel carrier and a brake caliper, wherein the wheel carrier and the brake caliper together form the wheel carrier and brake caliper device as an integral cast component, wherein the wheel carrier and brake caliper device encloses a cavity, through which cooling air for cooling the wheel carrier and brake caliper device can be passed, and wherein the cavity extends from a basic section of the wheel carrier into a neck section of the wheel carrier and tapers in the process.

According to one embodiment, the cavity extends from a basic section of the wheel carrier into a neck section of the wheel carrier and tapers in the process.

The fact that the cavity “tapers” starting from the basic section in the direction of the neck section is to be understood here as meaning that a cross-section or a cross-sectional area of the cavity becomes smaller or decreases in size starting from the basic section in the direction of the neck section. In particular, this means that the cavity comprises a larger cross-sectional area in the area of the basic section than in the area of the neck section. The neck section can therefore act as a chimney due to this tapering or narrowing of the cavity. This can create a chimney effect within the neck section which, when the vehicle is stationary, allows warm cooling air to flow from the brake caliper into the neck section, rise upwards in it and leave the wheel carrier and brake caliper device via suitable openings or breakthroughs, in particular air outlet openings. This enables the wheel carrier and brake caliper device to be cooled even when the vehicle is stationary.

According to another embodiment, the neck section is curved, in particular curved in the shape of an arc.

Viewed along the height direction, the neck section extends out of the upper side of the basic section. Viewed along the length direction, the neck section preferably extends in the direction of the brake caliper and can protrude over the brake caliper at least in sections.

According to another embodiment, a hydraulic canal is integrated into the brake caliper, which fluidically connects a first double brake cylinder of the brake caliper with a second double brake cylinder of the brake caliper.

The fact that the hydraulic canal is “integrated” into the brake caliper means in this case that the hydraulic canal runs inside the brake caliper and passes through it. The hydraulic canal can be created, for example, using a suitable sand core or salt core, which is inserted into the mold for manufacturing the wheel carrier and brake caliper device. Because the hydraulic canal is integrated into the brake caliper, there is no need for external hydraulic lines or brake fluid lines. Each double brake cylinder can comprise a first bore and a second bore. These bores can accommodate the aforementioned brake pistons, which can be used to actuate the brake pads. For example, the first bores or the second bores of the two double brake cylinders are in fluid connection via the hydraulic canal. Furthermore, such a hydraulic canal can also be provided between the first bore and the second bore of each double brake cylinder in order to fluidically connect the first bore and the second bore with each other. Brake fluid is fed through the hydraulic canal. Several hydraulic canals can be provided.

According to another embodiment, the wheel carrier and brake caliper device comprises a first cavity which is assigned to the wheel carrier, and a second cavity which is assigned to the brake caliper.

The first cavity is located inside the wheel carrier, in particular inside the neck section. Accordingly, the second cavity is located within the brake caliper. Alternatively, instead of a first cavity and a second cavity, a common cavity can be provided, which is provided both within the wheel carrier and within the brake caliper.

According to another embodiment, the first cavity is separated from the second cavity by means of a partition wall, wherein the partition wall comprises a breakthrough via which the first cavity and the second cavity are in fluid communication.

The partition wall is thus assembled between the first cavity and the second cavity. The partition wall can comprise any number of breakthroughs through which cooling air can flow from the first cavity into the second cavity or vice versa. The fact that the first cavity and the second cavity are “in fluid connection” means in particular that the cooling air can flow from the first cavity into the second cavity and vice versa.

According to another embodiment, the second cavity comprises a bottom through which cooling air can flow.

The bottom is preferably arranged perpendicular to the partition wall provided between the first cavity and the second cavity. In the present case, “perpendicular” means an angle of 90°±10°, preferably of 90°±5°, more preferably of 90°±3°, more preferably of 90°±1°, more preferably of exactly 90°. In particular, the cooling air can flow through the bottom in that the bottom comprises an air outlet opening that opens out of the second cavity and opens into the receiving section of the brake caliper. The cooling air can flow from the second cavity to the receiving section of the brake caliper through the air outlet opening provided in the bottom of the second cavity. The air outlet opening opens into the receiving section for this purpose. The air outlet opening is in fluid connection with the second cavity and in fluid connection with the first cavity via the breakthrough provided in the partition wall arranged between the cavities.

According to another embodiment, the wheel carrier comprises an air inlet opening for letting cooling air into the cavity.

Any number of air inlet openings can be provided. Preferably, the air inlet opening is provided on the neck section. The air inlet opening may comprise a rectangular geometry with rounded corners or a circular geometry. Several air inlet openings with different geometries can be provided. When the vehicle is moving, the cooling air flows in through the air inlet opening. A plurality of air outlet openings can be provided through which the cooling air can flow out of the cavity again. These air outlet openings can be provided on the neck section.

Due to the plurality of air inlet openings and the plurality of air outlet openings, the neck section comprises in particular a skeletal or truss-like structure. This means in particular that the air inlet openings and/or the air outlet openings are only separated from each other by thin webs or material webs.

According to another embodiment, a cooling air guidance element, which is funnel-shaped at least in sections, is provided at the air inlet opening.

In the event that several air inlet openings are provided, the cooling air guidance element can be provided at one of the air inlet openings. The cooling air guidance element can be a chamfer or bevel provided on the air inlet opening. Alternatively, the cooling air guidance element may be a component separate from the wheel carrier and caliper assembly and mounted to the wheel carrier and caliper assembly. The cooling air guidance element can comprise a funnel section for the inlet of the cooling air, a canal section for supplying the cooling air and an outlet section from which the cooling air flows out. The funnel section is preferably arranged outside the wheel carrier and brake caliper device. In particular, this means that the funnel section can protrude from the wheel carrier and brake caliper device. The cooling air guidance element can, for example, be inserted into the air inlet opening. With the help of the canal section, the cooling air can, for example, be introduced through the first cavity directly into the second cavity. The canal section can thus lead through the first cavity. The outlet section preferably comprises a beveled front surface or end face. This front surface or front face can be configured to guide the cooling air directly to the breakthrough of the bottom of the second cavity. Together with the wheel carrier and brake caliper device, the cooling air guidance element can also form an integral component, in particular a single-piece material component. This means that the cooling air guidance element can be manufactured using the same casting process that is used to manufacture the wheel carrier and brake caliper device. The cooling air guidance element can also be soldered or welded to the wheel carrier and brake caliper device.

According to another embodiment, the brake caliper comprises an air outlet opening which opens into a receiving section of the brake caliper, wherein the air outlet opening is in fluid communication with the cavity.

In particular, the air outlet opening is in fluid communication with the second cavity, which in turn is in fluid communication with the first cavity. The air outlet opening can be used to supply cooling air to the brake disc and the brake pads, which dissipates heat from the brake caliper, the brake disc and/or the brake pads.

According to another embodiment, the receiving section comprises a breakthrough with the help of which cooling air can be conveyed out of the receiving section.

The receiving section can comprise any number of breakthroughs. The heated cooling air can be conveyed away from the brake caliper into the surroundings of the wheel carrier and brake caliper device via these breakthroughs.

According to another embodiment, the wheel carrier comprises an air outlet opening for discharging cooling air from the cavity.

Any number of air outlet openings can be provided. The air flowing into the cavity via the air inlet opening can leave the cavity again via the air outlet opening. Preferably, the air outlet openings are associated with the wheel carrier. In particular, the air outlet openings can be provided on the neck section. The previously mentioned skeletal or truss-like structure of the neck section results from this outlet opening or openings and the inlet opening or openings.

According to another embodiment, a breakthrough is provided between the wheel carrier and the brake caliper, wherein the wheel carrier is connected to the brake caliper by means of a web running at least in sections around the breakthrough.

Material savings can be achieved with the help of the breakthrough. This supplies a weight reduction and a cost reduction. The web, in turn, stiffens the wheel carrier and brake caliper device by connecting the wheel carrier to the brake caliper.

Furthermore, a wheel carrier and brake caliper module for a vehicle is proposed. The wheel carrier and brake caliper module comprises such a wheel carrier and brake caliper device, a wheel bearing for rotatably mounting a wheel of the vehicle on the wheel carrier and brake caliper device, a wheel hub to which the wheel can be coupled, a brake disc connected to the wheel hub, a first brake pad, and a second brake pad, wherein the brake disc is arranged between the first brake pad and the second brake pad.

The brake disc is preferably an internally ventilated brake disc. For example, the brake disc can be riveted or bolted to the wheel hub. The wheel carrier and brake caliper module also preferably comprises brake pistons, as mentioned above, which are accommodated in the bores of the double brake cylinders.

According to one embodiment, the first brake pad and/or the second brake pad comprises a recess which allows the brake disc to be tilted during assembly and disassembly thereof.

As the brake caliper is permanently connected to the wheel carrier, it is not possible to remove the brake caliper. It is therefore necessary to tilt the brake disc in order to mount and remove it. To prevent the brake disc from colliding with one of the brake pads, at least one of the brake pads comprises a recess of this type. The recess can be designed as an annular groove running around the respective brake disc. Both brake pads can also each comprise such a recess.

The embodiments and features described for the proposed wheel carrier and brake caliper device apply mutatis mutandis to the proposed wheel carrier and brake caliper module and vice versa.

Further possible implementations of the wheel carrier and brake caliper device and/or the wheel carrier and brake caliper module also include combinations of features or embodiments described above or below with regard to the embodiment examples that are not explicitly mentioned. The person skilled in the art will also add individual aspects as improvements or additions to the respective basic form of the wheel carrier and brake caliper device and/or the wheel carrier and brake caliper module.

Further advantageous embodiments and aspects of the wheel carrier and brake caliper device and/or the wheel carrier and brake caliper module are the subject of the subclaims and of the embodiments of the wheel carrier and brake caliper device and/or the wheel carrier and brake caliper module described below. In the following, the wheel carrier and brake caliper device and/or the wheel carrier and brake caliper module are explained in more detail with reference to the attached figures.

### BRIEF DESCRIPTION OF THE DRAWINGS

FIG. 1 shows a schematic side view of one embodiment of a vehicle;

FIG. 2 shows a schematic perspective view of one embodiment of a wheel carrier and brake caliper device for the vehicle according to FIG. 1;

FIG. 3 shows a further schematic perspective view of the wheel carrier and brake caliper device according to FIG. 2;

FIG. 4 shows a schematic sectional view of the wheel carrier and brake caliper device according to FIG. 2;

FIG. 5 shows a further schematic perspective view of the wheel carrier and brake caliper device according to FIG. 2;

FIG. 6 shows a further schematic perspective view of the wheel carrier and brake caliper device according to FIG. 2;

FIG. 7 shows a further schematic perspective view of the wheel carrier and brake caliper device according to FIG. 2;

FIG. 8 shows a further schematic sectional view of the wheel carrier and brake caliper device according to FIG. 2; and

FIG. 9 shows a schematic sectional view of an embodiment of a wheel carrier and brake caliper module for the vehicle according to FIG. 1.

### DETAILED DESCRIPTION

In the figures, identical or functionally identical elements have been given the same reference symbols, unless otherwise stated.

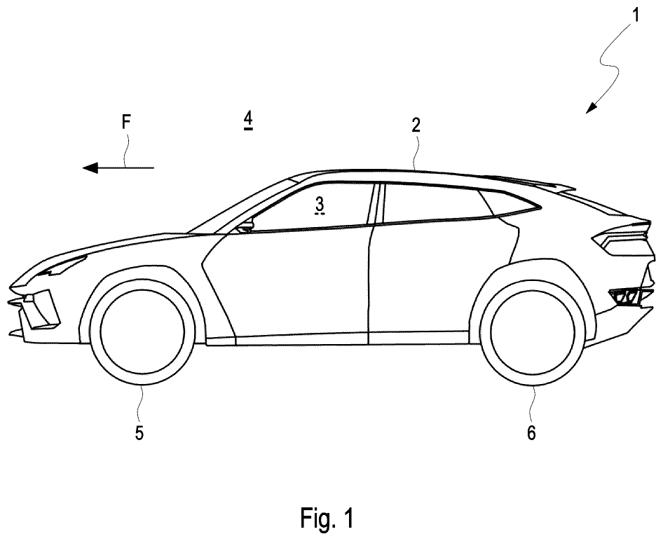

FIG. 1 shows a schematic side view of one embodiment of a vehicle 1. The vehicle 1 is a motor vehicle, in particular a passenger car. The vehicle 1 can also be a utility vehicle, for example a truck, a harvester or a construction machine. Furthermore, the vehicle 1 can also be a military vehicle. In the following, however, it is assumed that the vehicle 1 is a motor vehicle, in particular a passenger car.

The vehicle 1 comprises a car body 2 which encloses a passenger compartment or vehicle interior 3 of the vehicle 1. The vehicle interior 3 can accommodate a driver and passengers. The car body 2 delimits a surroundings 4 of the vehicle 1 from the vehicle interior 3. The vehicle interior 3 is accessible from the surroundings 4 by means of doors. The vehicle 1 comprises a chassis with several wheels 5, 6. The number of wheels 5, 6 is basically arbitrary. Preferably, the vehicle 1 comprises four wheels 5, 6. However, the vehicle 1 may also comprise six wheels 5, 6, for example. The wheels 5, 6 are part of a chassis of the vehicle 1. Only two wheels 5, 6 can be driven. However, all wheels 5, 6 can also be driven. In this case, the vehicle 1 is a four-wheel drive vehicle. The vehicle 1 can move along and against a driving direction F.

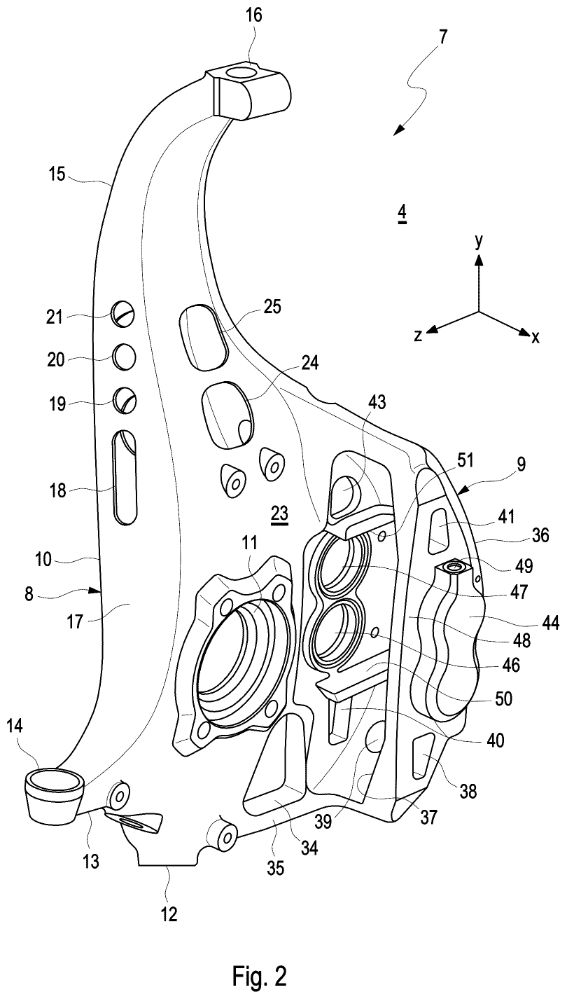

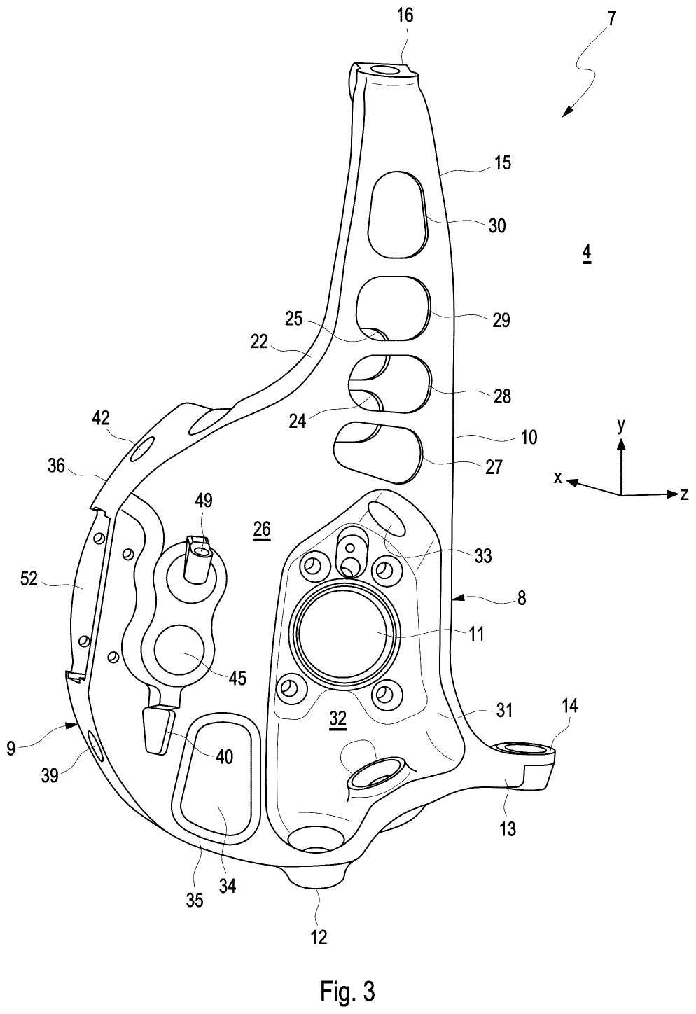

FIG. 2 shows a schematic perspective view of one embodiment of a wheel carrier and brake caliper device 7 for the vehicle 1. FIG. 3 shows a further schematic perspective view of the wheel carrier and brake caliper device 7. Reference is made below to FIGS. 2 and 3 simultaneously.

A coordinate system comprising an x-direction or length direction x, a y-direction or height direction y and a z-direction or depth direction z is assigned to the wheel carrier and brake caliper device 7. The directions x, y, z are oriented perpendicular to each other.

The wheel carrier and brake caliper device 7 is part of the chassis of the vehicle 1, in particular part of a wheel suspension of one of the wheels 5, 6. The vehicle 1 may comprise several such wheel carrier and brake caliper devices 7. Each wheel 5, 6 can be assigned such a wheel carrier and brake caliper device 7. This means that the vehicle 1 can comprise four such wheel carrier and brake caliper devices 7.

The wheel carrier and brake caliper device 7 combines a wheel carrier 8 with a brake caliper 9. The wheel carrier 8 and the brake caliper 9 are part of the wheel carrier and brake caliper device 7. The wheel carrier 8 and the brake caliper 9 form an integral component, in particular a one-piece material component, namely the wheel carrier and brake caliper device 7. The wheel carrier and brake caliper device 7 can be made of an aluminum alloy. However, other materials can also be used. Cooling performance can be increased by selecting a suitable material.

“Integral” or “one-piece” here means that the wheel carrier and brake caliper device 7 is not composed of separate subcomponents, but that the wheel carrier 8 and the brake caliper 9 are integrated into each other and cannot be separated from each other. “One-piece material” means that the wheel carrier and brake caliper device 7 are made of the same material throughout. The wheel carrier and brake caliper device 7 is therefore a monolithic component. For example, the wheel carrier and brake caliper device 7 is a low-pressure cast component or a gravity cast component.

The wheel carrier 8 comprises a basic section 10 to which the brake caliper 9 is connected. A stepped breakthrough 11 is provided on the basic section 10, which is configured to accommodate a wheel bearing, for example in the form of a roller bearing, of the respective wheel 5, 6. In the orientation shown in FIGS. 2 and 3, a first connection area 12, to which a lower wishbone can be connected, extends from the bottom side of the basic section 10.

An arm section 13 also extends out of the basic section 10. A second connection area 14 is provided on the arm section 13. A track rod can be connected to the second connection area 14. In the orientation shown in FIGS. 2 and 3, a curved, in particular an arcuately curved, neck section 15 comprising a third connection area 16 adjoins the upper side of the basic section 10. An upper wishbone can be connected to the third connection area 16.

A front side 17 of the wheel carrier and brake caliper device 7 extends from the arm section 13 via the basic section 10 to the neck section 15. A plurality of air inlet openings 18 to 21 are provided on the front side 17, through which cooling air can flow into the wheel carrier and brake caliper device 7 and flow out of it again. The wheel carrier and brake caliper device 7 is therefore hollow. For example, the air inlet opening 18 is rectangular with rounded corners. The air inlet openings 19 to 21 can be round. In principle, however, the air inlet openings 18 to 21 can comprise any geometry.

Facing away from the front side 17, the wheel carrier and brake caliper device 7 comprises a rear side 22. Furthermore, the wheel carrier and brake caliper device 7 comprises a first side wall 23 with a plurality of air outlet openings 24, 25. For example, the air outlet openings 24, 25 are rectangular with rounded corners. However, the air outlet openings 24, 25 can comprise any geometry. The air outlet openings 24, 25 may be in fluid communication with the air inlet openings 18 to 21.

A second side wall 26 facing away from the first side wall 23 also comprises a plurality of air outlet openings 27 to 30. The air outlet openings 27 to 30 can comprise any geometry. The air outlet openings 27 to 30 are in fluid communication with the air inlet openings 18 to 21 and the air outlet openings 24, 25.

A deepening 31 is provided on the second side wall 26. The deepening 31 comprises a bottom 32, which is set back with respect to the second side wall 26. The breakthrough 11 is provided at the bottom 32. An air outlet opening 33 opens into the deepening 31. The air outlet opening 33 can be in fluid communication with the air inlet openings 18 to 21 and the air outlet openings 24, 25, 27 to 30. A breakthrough 34 is provided between the wheel carrier 8 and the brake caliper 9. In the area of the breakthrough 34, the wheel carrier 8 is connected to the brake caliper 9 via a web 35.

The brake caliper 9 comprises a receiving section 36 which is suitable for at least partially receiving brake pistons, a brake disc and brake pads. The receiving section 36 comprises a recess 37, which is suitable for receiving the brake pads and the brake disc, at least in sections. Several breakthroughs 38 to 42 open into the recess 37, via which the recess 37 is in fluid connection with the surroundings 4. Furthermore, an air outlet opening 43, which is in fluid connection with the air inlet openings 18 to 21 and the air outlet openings 24, 25, 27 to 30, 33, opens into the recess 37.

Two double brake cylinders 44, 45 located opposite one another are provided on the receiving section 36. Each double brake cylinder 44, 45 can accommodate two brake pistons. For this purpose, each double brake cylinder 44, 45 can comprise two circular cylinder-shaped bores 46, 47, in each of which a brake piston is accommodated. A first double brake cylinder 44 extends out of a side wall 48 of the receiving section 36. The side wall 48 is offset from the first side wall 23. A second double brake cylinder 45 extends out of the second side wall 26.

The second double brake cylinder 45 comprises a connection 49 for connecting a brake fluid line. The first double brake cylinder 44 can also comprise such a connection 49. However, this is not absolutely necessary. Each double brake cylinder 44, 45 is assigned two guidance rails 50, 51 on which the brake pads are guided. On the rear side, i.e. on the rear side 22, the receiving section 36 comprises an opening 52 through which, for example, the brake pads accommodated in the receiving section 36 are accessible.

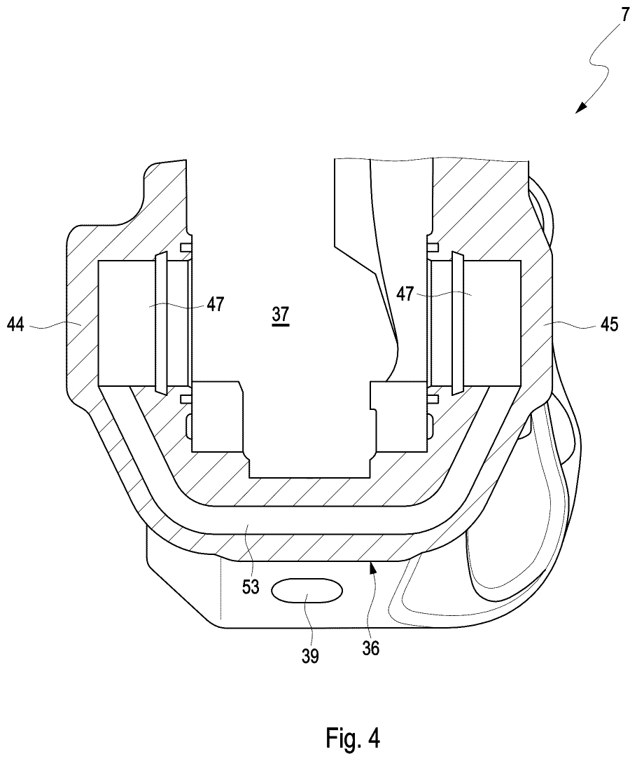

FIG. 4 shows a schematic sectional view of the wheel carrier and brake caliper device 7 at the height of the double brake cylinders 44, 45.

As shown in FIG. 4, a hydraulic canal 53 is provided within the wheel carrier and brake caliper device 7, in particular within the receiving section 36 of the brake caliper 9, which fluidically connects the two bores 47 of the double brake cylinders 44, 45 to one another. Furthermore, such a hydraulic canal 53 can also be provided, which fluidically connects the two bores 46 to one another.

In addition, the bores 46, 47 of each double brake cylinder 44, 45 may be in fluid communication with each other. Brake fluid is conducted through the hydraulic canal 53 during operation of the vehicle 1. The hydraulic canal 53 is integrated into the wheel carrier and brake caliper device 7 during casting of the wheel carrier and brake caliper device 7. Additional brake fluid lines connecting the double brake cylinders 44, 45 can advantageously be dispensed with.

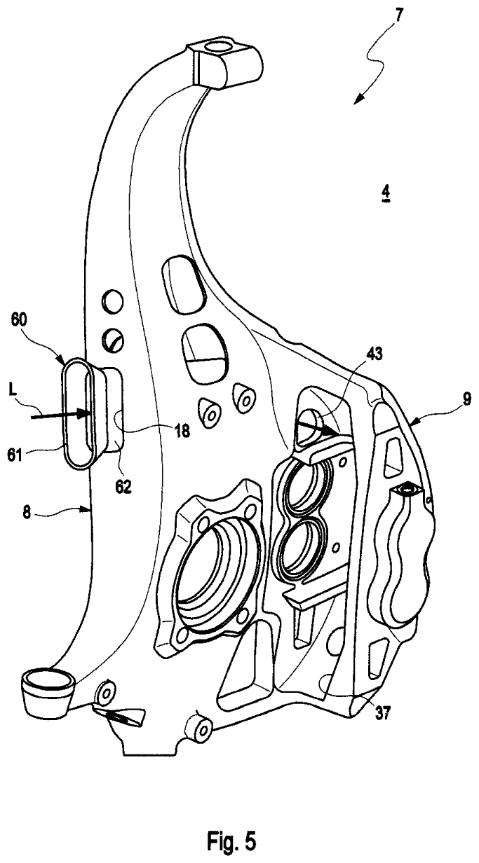

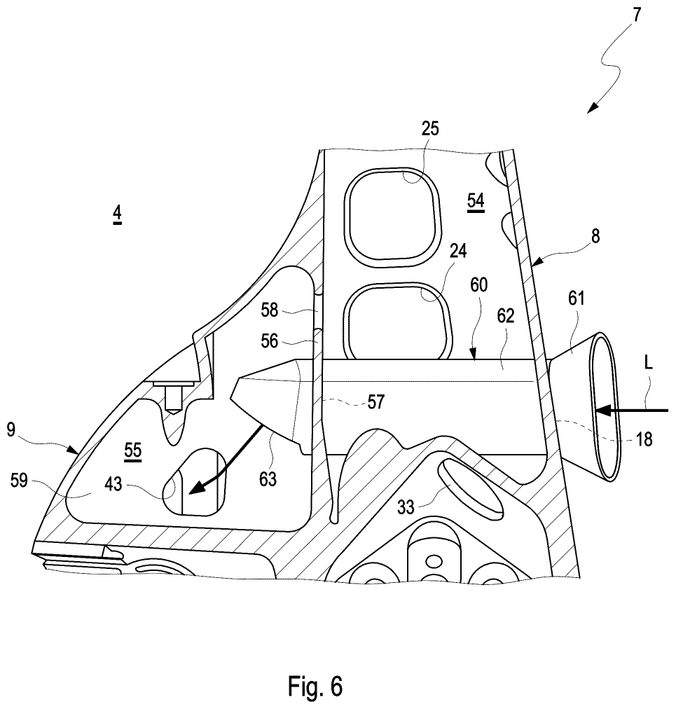

FIGS. 5 and 6 each show a further schematic perspective view of the wheel carrier and brake caliper device 7. Reference is made below to FIGS. 5 and 6 simultaneously.

FIG. 6 shows the wheel carrier and brake caliper device 7 in partial section. The wheel carrier 8 encloses a first cavity 54, which extends from the basic section 10 into the neck section 15. The first cavity 54 is accessible via the air inlet openings 18 to 21 and the air outlet openings 24, 25, 27 to 30, 33.

The brake caliper 9 comprises a second cavity 55, which is enclosed by the brake caliper 9. The cavities 54, 55 are separated from one another by a partition wall 56. The partition wall 56 comprises breakthroughs 57, 58 via which the cavities 54, 55 are in fluid communication with one another. The air outlet opening 43, which opens into the receiving section 36 of the brake caliper 9, is provided at a bottom 59 of the second cavity 55.

In particular, the cavities 54, 55 extend along the height direction y of the wheel carrier and brake caliper device 7. The height direction y is oriented from the first connection area 12 or from the second connection area 14 in the direction of the third connection area 16. Along the height direction y, the respective cavity 54, 55 comprises its greatest geometric extent. This means that the geometric extent of the respective cavity 54, 55 along the height direction y is greater than along the length direction x and the depth direction z.

When the vehicle 1 moves along the driving direction F, cooling air L is forced into the first cavity 54 via the air inlet openings 18 to 21. Chamfers may be provided at the air inlet openings 18 to 21, in particular at the air inlet opening 18, in order to create a funnel-shaped inlet geometry which facilitates the inflow of the cooling air L into the first cavity 54.

The cooling air L can then flow into the second cavity 55 via the breakthroughs 57, 58 and from there be directed into the receiving section 36 via the air outlet opening 43 in order to cool the brake disc, the brake pads and the brake caliper 9, which are at least partially received in the receiving section 36. The cooling air L flows along the brake disc and removes heat from it. The heated cooling air L can flow out of the brake caliper 9 via the break-throughs 38 to 42.

Optionally, a cooling air guidance element 60 may be provided. The cooling air guidance element 60 can be a component separate from the wheel carrier and brake caliper device 7, which is connected to the wheel carrier and brake caliper device 7 after it has been manufactured. However, this is not absolutely necessary. The cooling air guidance element 60 can also be formed integral, in particular in one piece of material, with the wheel carrier and brake caliper device 7.

The cooling air guidance element 60 is received in the air inlet opening 18 and extends through the first cavity 54 and the breakthrough 57 into the second cavity 55. The cooling air guidance element 60 includes a funnel section 61, a canal section 62 adjoining the funnel section 61 and an outlet section 63 adjoining the canal section 62.

The funnel section 61 is funnel-shaped (e.g., at a cooling air (L) inlet section as shown in FIGS. 5-7) and makes it easier for the cooling air L to flow in. The cooling air L is conveyed through the first cavity 54 into the second cavity 55 with the help of the canal section 62. The outlet section 63 guides the cooling air L directly to the air outlet opening 43. For this purpose, the outlet section 63 is beveled on the end face.

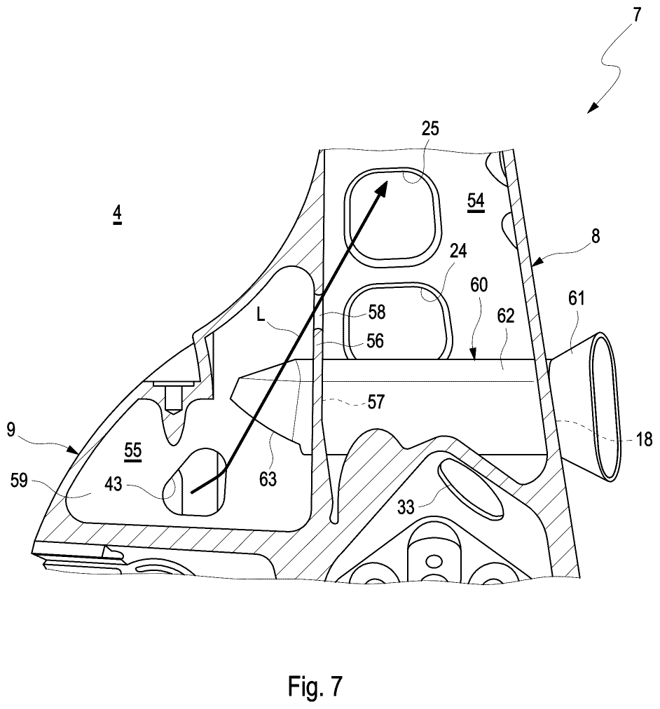

FIG. 7 shows a further schematic perspective view of the wheel carrier and brake caliper device 7.

In FIG. 7, the wheel carrier and brake caliper device 7 is shown partially cut. The vehicle 1 is now at a standstill, so that the cooling air L is no longer directed through the wheel carrier and brake caliper device 7 for cooling purposes by a driving movement of the vehicle 1, as previously explained. However, there is a flow of cooling air L, in particular a reverse flow, through the cavities 54, 55 and the breakthrough 58, which is generated by a chimney effect.

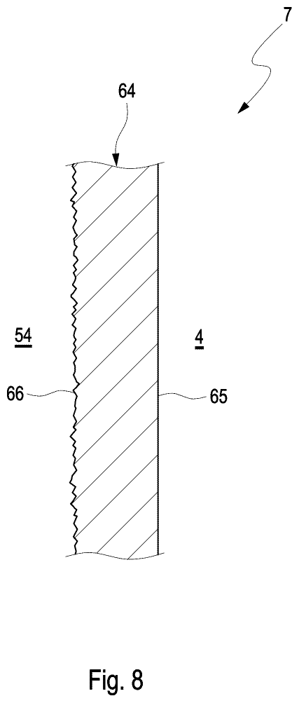

FIG. 8 shows a further schematic sectional view of the wheel carrier and brake caliper device 7.

In particular, FIG. 8 shows a section through a wall 64 of the wheel carrier and brake caliper device 7. The wall 64 separates, for example, the first cavity 54 from the surroundings 4. The wall 64 comprises an outer side 65 facing the surroundings 4, which faces away from the first cavity 54, and an inner side 66 facing the first cavity 54, which faces away from the surroundings 4. The outer side 65 can, for example, be part of the front side 17, the rear side 22 or one of the side walls 23, 26.

The inner side 66 comprises a greater roughness compared to the outer side 65. For example, a center roughness value Ra of at least 15 um can be aimed for on the inner side 66. A targeted surface texture or surface structuring is thus provided on the inner side 66. The inner side 66 can be embossed by the molding sand used, which can comprise the geometry of polyhedrons with a non-repeatable structure. The surface structuring of the inner side 66 increases the heat transfer surface and thus improves heat dissipation.

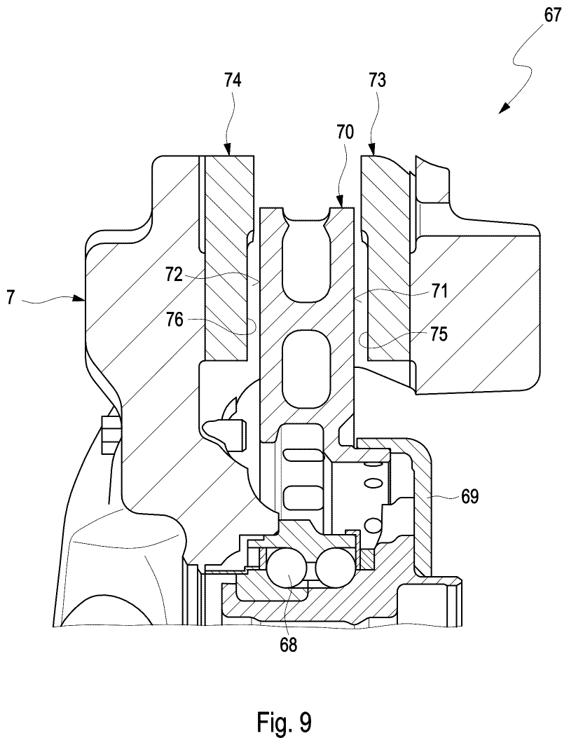

FIG. 9 shows a schematic sectional view of one embodiment of a wheel carrier and brake caliper module 67.

The wheel carrier and brake caliper module 67 comprises a wheel carrier and brake caliper device 7 as mentioned above, a wheel bearing 68 which is accommodated at least in sections in the breakthrough 11 of the wheel carrier 8, a wheel hub 69 and a brake disc 70 which is firmly connected to the wheel hub 69. The brake disc 70 can be an internally ventilated brake disc. However, this is not absolutely necessary. The brake disc 70 comprises two surfaces 71, 72 facing away from each other, which can be coated. A wear-free surface coating can be provided. This eliminates the need for maintenance work and is therefore a solution for the entire service life of the vehicle 1, thus reducing the total vehicle and operating costs and increasing the service life.

Furthermore, the wheel carrier and brake caliper module 67 comprises two brake pads 73, 74. A first brake pad 73 is assigned to the surface 71. A second brake pad 74 is assigned to the surface 72. To brake the respective wheel 5, 6, the brake pads 73, 74 are driven against the brake disc 70 with the aid of the brake pistons accommodated in the double brake cylinders 44, 45.

For mounting and removing the brake disc 70, the brake pads 73, 74 each comprise a recess 75, 76. The recesses 75, 76 allow the brake disc 70 to be tilted during installation and removal. The brake disc 70 therefore does not collide with the brake pads 73, 74 and jamming of the brake disc 70 is reliably prevented.

The wheel carrier and brake caliper device 7 can be used to improve handling and reduce noise emissions. There is no need to mount the wheel carrier 8 and the brake caliper 9, and there is no need for screws, cables or the like. Improved cooling of the brake caliper 9, the brake disc 70 and/or the brake pads 73, 74 is achieved.

This results in a more homogeneous heat distribution and better dissipation of heat from critical zones of the wheel carrier and brake caliper device 7. The cooling air L can be supplied in a targeted manner. Waste heat from the brake caliper 9, the brake disc 70 and/or the brake pads 73, 74 is dissipated in a targeted manner. The fact that the hydraulic canal 53 is integrated into the brake caliper 9 means that there is no need for an external brake fluid line. The wheel carrier and brake caliper module 67 is a maintenance-free service life module of the vehicle 1.

The wheel carrier and brake caliper device 7 is cast and machined in one piece. The improved rigidity reduces the overall weight of the wheel carrier and brake caliper device 7. Overall, the wheel carrier and brake caliper device 7 reduces the weight of the vehicle, in particular the unsprung masses, and improves handling. The wheel carrier and brake caliper device 7 directly reduces the energy consumption of the vehicle 1. The increased rigidity also supplies an improvement in wheel guidance.

The wheel carrier and brake caliper device 7 can be used to reduce overall costs, for example in manufacturing, procurement, logistics, assembly and the like. The CO2 balance is improved because the wheel carrier 8 and the brake caliper 9 can be produced in one casting at one location rather than in two plants far apart. This applies to the casting itself, a necessary heat treatment, in that only one heat treatment process is necessary, and also a final machining of the wheel carrier and brake caliper device 7.

Only one transportation process from a supplier to the customer is required. There is no need to transport a separate brake caliper, connecting bolts, washers and brake fluid lines. This means that only one logistics route is required at the vehicle plant. The energy savings and therefore the reduction in CO2 emissions are considerable thanks to the combination of processes. The thermal load capacity is increased. The wheel carrier and brake caliper device 7 can be made smaller and lighter. The weight reduction has a direct effect on lower fuel consumption and energy consumption.

The brake caliper 9 comprises a maximum connection cross-sectional area to the wheel carrier 8, which ensures optimized heat dissipation from the brake caliper 9 into the wheel carrier 8. This connection cross-sectional area ensures a more even heat distribution in the wheel carrier and brake caliper device 7. Furthermore, the heat dissipation from critical areas, such as the brake pads 73, 74 or the brake fluid, is also significantly improved.

To produce the cavities 54, 55, sand cores or salt cores are inserted into the mold for producing the wheel carrier and brake caliper device 7. These sand cores are then destroyed, leaving behind the respective cavities 54, 55. In the event that salt cores are provided, these can then be rinsed out, leaving behind the respective cavities 54, 55.

On the one hand, the cavities 54, 55 have the purpose of reducing weight. On the other hand, the cavities 54, 55 serve as cooling canals with the appropriate assembly and/or geometry. Alternatively, these cooling canals can also be formed by air ducts made of plastic or other materials inserted into the cavities 54, 55. The orientation, shape and/or positioning is determined by the respective vehicle conditions.

The cavities 54, 55 in the interior of the wheel carrier and brake caliper device 7 are utilized to dissipate braking heat by means of a specific surface texture of the inner side 66 and air ducts. The inner side 66 can be embossed by the molding sand used, which can comprise grains of sand in the form of polyhedrons with a non-repeatable structure. In particular, the molding sand used is deliberately selected to be coarse in order to produce the surface structuring of the inner side 66. This opens up further freedom in the design of the shape and size of the wheel carrier 8 and/or the brake caliper 9.

The second cavity 55 leads horizontally through the wheel carrier and brake caliper device 7 as viewed from the front along the driving direction F. Here, the cooling air L is supplied through the first cavity 54 with the aid of the cooling air guidance element 60. The cooling air L then exits the air outlet opening 43 into the receiving section 36 of the brake caliper 9. The second cavity 55 is then used to cool the brake disc 70 and brake caliper 9 while the vehicle 1 is in motion, in that the cooling air L flows against and/or through the brake disc 70 and the brake caliper 9.

The first cavity 54, which is in fluid connection with the second cavity 55, is supplied through the hollow neck section 15 of the wheel carrier 8 and exits at an upper end of the neck section 15 in the area of the third connection area 16. The first cavity 54 thus serves to dissipate heat when the vehicle 1 is stationary. Here, the chimney effect of the neck section 15 causes the heated cooling air L to be extracted through the neck section 15 from the area of the brake caliper 9, passed through the neck section 15 and dissipated through the air outlet openings 24, 25, 27 to 30 of the neck section 15.

Cooling canals can be formed within the cavities 54, 55 by webs. These webs enable a desired air flow inside the respective cavity 54, 55. The webs can also be directly cast in, for example in the form of partition wall 56. A fin can be used to realize a partially integrated anchor plate on the wheel carrier and brake caliper device 7. If space is limited or if greater strength is required, it may be necessary to reinforce the wheel carrier and brake caliper device 7 locally. For this purpose, inserts made of a different material, such as steel, can be inserted into the mold and encapsulated with the material from which the wheel carrier and brake caliper device 7 is made.

Although the present invention has been described with reference to examples of embodiments, it can be modified in many ways.

### LIST OF REFERENCE SIGNS

1 Vehicle
2 Car body
3 Vehicle interior
4 Surroundings
5 Wheel
6 Wheel
7 Wheel carrier and brake caliper device
8 Wheel carrier
9 Brake caliper
10 Basic section
11 Breakthrough
12 Connection area
13 Arm section
14 Connection area
15 Neck section
16 Connection area
17 Front side
18 Air inlet opening
19 Air inlet opening
20 Air inlet opening
21 Air inlet opening
22 Rear side
23 Side wall
24 Air outlet opening
25 Air outlet opening
26 Side wall
27 Air outlet opening
28 Air outlet opening
29 Air outlet opening
30 Air outlet opening
31 Deepening
32 Bottom
33 Air outlet opening
34 Breakthrough
35 Web
36 Receiving section
37 Recess
38 Breakthrough
39 Breakthrough
40 Breakthrough
41 Breakthrough
42 Breakthrough
43 Air outlet opening
44 Double brake cylinder
45 Double brake cylinder
46 Bore
47 Bore
48 Side wall
49 Connection
50 Guidance rail
51 Guidance rail
52 Opening
53 Hydraulic canal
54 Cavity
55 Cavity
56 Partition wall
57 Breakthrough
58 Breakthrough
59 Bottom
60 Cooling air guidance element
61 Funnel section
62 Canal section
63 Outlet section
64 Wall
65 Outer side
66 Inner side
67 Wheel carrier and brake caliper module
68 Wheel bearing
69 Wheel hub
70 Brake disk
71 Surface
72 Surface
73 Brake pad
74 Brake pad
75 Recess
76 Recess
F Driving direction
L Cooling air
x Length direction
y Height direction
z Depth direction

1. A wheel carrier and brake caliper device for a vehicle, comprising:
a wheel carrier; and
a brake caliper,
wherein the wheel carrier and the brake caliper together form the wheel carrier and brake caliper device as an integral cast component,
wherein the wheel carrier and brake caliper device encloses a cavity through which cooling air can be passed for cooling the wheel carrier and brake caliper device,
wherein a wall of the wheel carrier and brake caliper device, which separates the cavity from a surroundings of the wheel carrier and brake caliper device, comprises an inner side facing the cavity and an outer side facing the surroundings, and
wherein the inner side comprises a greater surface roughness than the outer side.

2. The wheel carrier and brake caliper device according to claim 1, wherein the cavity extends from a basic section of the wheel carrier to a neck section of the wheel carrier, the cavity having a taper from the basic section in a direction of the neck section.

3. The wheel carrier and brake caliper device according to claim 2, wherein the neck section is curved in a shape of an arc.

4. The wheel carrier and brake caliper device according to claim 1, further comprising a hydraulic canal integrally formed in the brake caliper, configured to fluidically connect a first double brake cylinder of the brake caliper to a second double brake cylinder of the brake caliper.

5. The wheel carrier and brake caliper device according to claim 1, further comprising:
a first cavity defined by the wheel carrier; and
a second cavity defined by the brake caliper.

6. The wheel carrier and brake caliper device according to claim 5, wherein the first cavity is separated from the second cavity by a partition wall, wherein the partition wall defines a breakthrough configured to place the first cavity and the second cavity are in fluid communication.

7. The wheel carrier and brake caliper device according to claim 6, wherein the brake caliper further defines an air outlet positioned toward a bottom of the second cavity, the air outlet configured to allow the cooling air to flow through the bottom of the second cavity.

8. The wheel carrier and brake caliper device according to claim 1, wherein the wheel carrier defines an air inlet opening configured to allow the cooling air to flow from the surroundings into the cavity.

9. The wheel carrier and brake caliper device according to claim 8, further comprising a cooling air guidance element positioned at the air inlet opening, the cooling air guidance element is funnel-shaped at least at a cooling air inlet section.

10. The wheel carrier and brake caliper device according to claim 1, wherein the brake caliper comprises an air outlet opening which opens into a receiving section of the brake caliper, wherein the air outlet opening is in fluid communication with the cavity.

11. The wheel carrier and brake caliper device according to claim 10, wherein the receiving section comprises a breakthrough configured to allow the cooling air to flow out of the receiving section to the surroundings.

12. The wheel carrier and brake caliper device according to claim 1, wherein the wheel carrier comprises an air outlet opening for discharging the cooling air from the cavity.

13. The wheel carrier and brake caliper device according to claim 1, wherein a breakthrough is provided between the wheel carrier and the brake caliper, wherein the wheel carrier is connected to the brake caliper by a web, the web defining at least a portion of the breakthrough.

14. A wheel carrier and brake caliper module for a vehicle, comprising:
a wheel carrier and brake caliper device according to claim 1;
a wheel bearing for rotatably mounting a wheel of the vehicle on the wheel carrier and brake caliper device;
a wheel hub to which the wheel can be coupled;
a brake disc which is connected to the wheel hub;
a first brake pad; and
a second brake pad, wherein the brake disc is arranged between the first brake pad and the second brake pad.

15. The wheel carrier and brake caliper module according to claim 14, wherein at least one of the first brake pad and/or the second brake pad comprises a recess configured to allow the brake disc to be tilted during assembly and disassembly thereof with the wheel carrier and brake caliper device.

16. The wheel carrier and brake caliper device according to claim 2, wherein the cavity comprises:
a first cavity defined by the wheel carrier and having the taper; and
a second cavity defined by the brake caliper, the second cavity in fluid communication with the first cavity.

17. The wheel carrier and brake caliper device according to claim 16, wherein the wheel carrier defines an air inlet opening configured to allow the cooling air to flow from the surroundings into the first cavity.

18. A wheel carrier and brake caliper device for use on a vehicle, the wheel carrier and brake caliper device comprising:
a wheel carrier comprising:
a first side wall;
a second side wall;
a front side positioned between and connected to the first side wall and the second side wall; and
a rear side positioned between and connected to the first side wall and the second side wall, wherein the first side wall, the second side wall, the front side and the rear side define a cavity between the respective sides, each of the first side wall, the second side wall, the front side and the rear side include an inner side facing the cavity and an outer side facing a surrounding of the wheel carrier and brake caliper device, wherein at least one of the inner side of the respective first side wall, the second side wall, the front side, or the rear side includes a greater surface roughness than the outer side of the respective first side wall, the second side wall, the front side, and the rear side; and
a caliper device integrally formed with the wheel carrier, the caliper device including a receiving section extending in a length direction x relative to the wheel carrier, the receiving section defining a recess configured to receive a portion of a brake disk, a first brake pad, and a second brake pad positioned in the recess, the recess in fluid communication with the cavity in the wheel carrier to allow a flow of cooling air from the surroundings through the cavity to the recess to cool the brake disk, the first brake pad and the second brake pad, the caliper device further comprising;
a first double take brake cylinder integrally formed in the receiving section;
a second double take brake cylinder integrally formed in the receiving section; and
a hydraulic canal integrally formed in the receiving section in fluid communication with the first double take brake cylinder and the second double take brake cylinder.

19. The wheel carrier and brake caliper device according to claim 18, wherein the wheel carrier further defines at least one air inlet opening in fluid communication with the cavity, wherein the cavity further comprises:
a first cavity defined by the wheel carrier in fluid communication with the at least one air inlet opening; and
a second cavity defined by the caliper device in fluid communication with the first cavity and the recess in the receiving section, wherein the first cavity, the second cavity and the recess are configured to allow the flow of the cooling air from the surrounding through the at least one air inlet opening, through the first cavity, through the second cavity and into the recess to cool the brake disk, the first brake pad and the second brake pad.

20. The wheel carrier and brake caliper device according to claim 19, further comprising a cooling air guidance element positioned in the at least one air inlet opening, the cooling air guidance element extending through the first cavity and into the second cavity to direct the cooling air into the second cavity toward the recess in the receiving section.
